(19) United States
(12) Patent Application Publication
(10) Pub. No.: US 2025/0147312 A1
(43) Pub. Date: May 8, 2025

(54) OPTICAL APPARATUS FOR AUGMENTED REALITY

(71) Applicant: PRAZEN Co.,Ltd, Gyunggi-do (KR)

(72) Inventor: Heekyung Kim, Gyunggi-do (KR)

(21) Appl. No.: 18/518,467

(22) Filed: Nov. 23, 2023

(30) Foreign Application Priority Data
Nov. 4, 2023 (KR) 10-2023-0151263

(51) Int. Cl. G02B 27/01

(52) U.S. Cl. CPC G02B 27/0172; G02B 2027/0174; G02B 2027/0178

(57) ABSTRACT

An optical device for augmented reality is disclosed, including an optical plate onto which light emitted from a display is incident; and a reflective surface having a shape of one or more free-form surfaces, one or more aspherical surfaces, one or more parabolic surfaces, or one or more conical surfaces, the reflective surface being contained in the optical plate, or a reflective surface having a shape of one or more free-form surfaces, one or more aspherical surfaces, one or more parabolic surfaces, or one or more conical surfaces, the reflective surface being contained in the optical plate and having a shape of one or more planar surfaces or one or more spherical surfaces; wherein the emitted light forms a predetermined optical path by the reflective surface and is guided into the user's view, and the optical path does not include a path reflected from the surface of the optical plate.

### CROSS-REFERENCE TO RELATED APPLICATIONS

The present application claims priority under 35 U.S.C 119(a) to Korean Patent Application No. 10-2023-0151263, filed on Nov. 4, 2023, which is incorporated herein by reference in its entirety.

### FIELD OF THE INVENTION

The present invention relates to an optical apparatus for augmented reality.

### BACKGROUND OF THE INVENTION

Augmented Reality (AR) is the practice of showing virtual videos or images as if they actually exist. This is achieved by providing a virtual video or image generated by a computer, etc., overlaid on an object or environment that actually exists in the real world.

In order to implement this augmented reality, there is a need for an optical apparatus that can provide virtual pictures or images created by an arithmetic processing device such as a computer by overlapping them with objects or environments in the real world.

These optical apparatuses generally adopt an optical system that reflects or refracts virtual pictures or images to the head-worn type or glass type wearable apparatuses.

Wearable devices with optical systems may use waveguides, diffractive optical elements (DOEs) or holographic optical elements (HOEs) in the form of glass or plastic plates, to improve user comfort and reduce the substrate thickness of the optical system.

However, this waveguide/DOE (HOE) type optical system, due to low optical efficiency, sensitive wavelength selectivity, etc., has a problem in that augmented reality picture or image provided by the apparatus is dark and color blur is severe that the image quality deteriorates. In addition, since waveguides corresponding to each of the colors R (red), G (green), and B (blue) must be used, there is a problem in that the overall thickness of the optical system becomes thicker again.

To overcome these challenges, the demand for the necessary skills is increasing.

### PRIOR ART LITERATURE

### [Patent Document]

[Patent Document] KR 10-2582246 B1

### SUMMARY OF THE INVENTION

The present invention provides an optical system which is thinner and lighter while providing high luminous efficiency and clear images, and an optical apparatus for augmented reality which adopted the optical system.

According to the present invention, there is provided an optical device for augmented reality, which includes:
an optical plate onto which light emitted from a display is incident; and
a reflective surface having a shape of one or more free-form surfaces, one or more aspherical surfaces, one or more parabolic surfaces, or one or more conical surfaces, the reflective surface being contained in the optical plate, or a reflective surface having a shape of one or more free-form surfaces, one or more aspherical surfaces, one or more parabolic surfaces, or one or more conical surfaces, the reflective surface being contained in the optical plate and having a shape of one or more planar surfaces or one or more spherical surfaces;
wherein the emitted light forms a predetermined optical path by the reflective surface and is guided into the user's view, and the optical path does not include a path reflected from the surface of the optical plate.

According to an embodiment of the present invention, the optical plate is made up of a plurality of subplates stacked in the thickness direction, and the subplates are formed by processing reflective surfaces with inverse shapes on surfaces facing other subplates, and then applying a reflective coating film to the reflective surfaces, to join the subplates so that the opposing reflective surfaces are in contact with each other.

According to another embodiment of the present invention, the reflective surface is arranged to form the optical path within the optical plate with a thickness of 5 mm to 12 mm.

According to another embodiment of the present invention, among the two or more reflective surfaces, a first reflective surface that first reflects the emitted light has a higher reflectivity than other reflective surfaces other than the first reflective surface.

According to another embodiment of the present invention, the first reflective surface that first reflects the emitted light has at least some a reflectivity of 30% or more.

According to another embodiment of the present invention, among the two or more reflective surfaces, at least a portion of a second reflective surface that last reflects into the user's view along the optical path has a reflectivity of 3% or more.

According to another embodiment of the present invention, the optical plate is made of a high refractive material with a refractive index of 1.6 or more.

According to another embodiment of the present invention, the reflective surfaces inside the optical plate include one or more free-form surfaces, one or more aspherical surfaces, and one or more spherical or planar reflective surfaces.

According to another embodiment of the present invention, all or part of the one or more reflective surfaces are symmetrical or asymmetrical free-form surfaces that comply with Equation 1, Equation 2, and Equation 3 below,

$${T}_{n} ( x ) = cos ( n {cos}^{- 1} ( x ) ) , n = 0 … ∞ , x ∈ [ - 1 , 1 ] \qquad [ Equation 1 ]$$

$$z = \frac{c ( {x}^{2} + {y}^{2} )}{1 + \sqrt{1 - {c}^{2} ( {x}^{2} + {y}^{2} )}} + {\sum }_{i = 0}^{N} {\sum }_{j = 0}^{M} {a}_{ij} \cdot {T}_{i} ( \overline{x} ) \cdot {T}_{j} ( \overline{y} ) \qquad [ Equation 2 ]$$

$${t}_{ij} ( x , y ) = {T}_{i} ( x ) \cdot {T}_{j} ( y ) , i , j = 0 … ∞ , x ∈ [ - 1 , 1 ] , y ∈ [ - 1 , 1 ] \qquad [ Equation 3 ]$$

here, z is the distance (sag) from the z axis of a specific point on the surface, aᵢⱼ is the coefficient of a Chebyshev Polynomial term, x and y are normalized surface coordinates, and n and m are the maximum polynomial degree in the x and y dimensions, and c is the curvature of the basic sphere to which the polynomial is added.

According to another embodiment of the present invention, all or part of the one or more reflective surfaces are symmetrical or asymmetrical freeform surfaces expressed in Equation 4 below,

$$z = \frac{( {cr}^{2} )}{1 + \sqrt{1 - ( 1 + k ) {c}^{2} {r}^{2}}} + {\sum }_{j = 2}^{66} {c}_{j} {x}^{m} {y}^{n} \qquad [ Equation 4 ]$$

here, z is the distance (sag) from the z-axis of a specific point on the surface, c is the vertex curvature of the curved surface, k is the Conic constant, and cⱼ is the coefficient of the monomial x^{m}yⁿ, and j is expressed in Equation 5 below,

$$j = \frac{{( m + n )}^{2} + m + 3 n}{2} + 1 \qquad [ Equation 5 ]$$

here, m and n are positive integers whose sum is 10 or less, and both m and n are not equal to 0.
11. The optical apparatus according to claim 1, wherein all or part of the one or more reflective surfaces are expressed in Equation 6 below, and are geometric surfaces in the form of spherical surface, aspherical surface, elliptic surface, parabolic surface, or hyperbolic surface,

$$z ( h ) = \frac{{h}^{2}}{{R}_{s} [ 1 + \sqrt{1 - ( 1 + k ) {( \frac{h}{{R}_{s}} )}^{2}} ]} + {\sum }_{n = 2}^{m} {A}_{2 n} {h}^{2 n} \qquad [ Equation 6 ]$$

Here, h is a radial coordinate, Rₛ is a vertex radius, k is a Conic constant, A₂ₙ is a coefficient of a polynomial, and when the geometric curved surface is oblate and paraboloid, k>0, when the geometric curved surface is a sphere, k=0, when the geometric curved surface is a conical paraboloid,
−1<k<0, when the geometric curved surface is a paraboloid, k=−1, or when the geometric curved surface is a hyperboloid, k<−1.

According to another embodiment of the present invention, the two or more reflective surfaces include a first reflective surface that first reflects the emitted light, a second reflective surface that finally reflects light into the user's view along the optical path, and a third reflective surface that is provided on the optical path between the first and second reflective surfaces to reflect light, and the third reflective surface includes a 3a reflective surface that uses the reflected light of the first reflective surface as incident light, a 3c reflective surface that uses the incident light of the second reflective surface as reflected light, and a 3b reflective surface that uses the incident light of the 3c reflective surface as reflected light.

According to another embodiment of the present invention, the first, second, and 3b reflective surfaces are free-form or aspherical surfaces, and the 3a and 3c reflective surfaces are planar or spherical surfaces.

According to another embodiment of the present invention, the first, second, 3a, 3b, and 3c reflective surfaces are free-form surfaces.

According to the present invention, there is provided Glasses including the optical apparatus for augmented reality according to any one of claims 1 to 14, wherein a display is located on one side of the glasses, and an optical path is formed in the horizontal or vertical direction of the glasses.

### Effects

The light efficiency of the existing waveguide optical system is very low, which is around 18. Meanwhile, the optical system according to an embodiment of the present invention may improve light efficiency by more than 50%. In addition, while the existing waveguide-type optical system has a problem of color uniformity deterioration due to the application of DOE or HOE with high wavelength dependence, the optical system according to an embodiment of the present invention uses reflection of light instead of diffraction phenomenon, whereby the problem of color uniformity deterioration may be solved.

Therefore, since the optical system according to an embodiment of the present invention has a thin thickness, high light efficiency and high chromaticity uniformity, it may greatly improve the user comfort of the wearable devices when applied thereto.

In addition, when the existing birdbath type optical system has the field of view, 60°, the optical system has a light efficiency of about 15% and the thickness of the optical system is about 14 mm. Meanwhile, the optical system according to an embodiment of the present invention has 50% higher light efficiency than a birdbath optical system and can be implemented with a thickness of about 6 to 7 mm by reducing the thickness by more than 60%, while maintaining the field of view, 60°.

### BRIEF DESCRIPTION OF THE DRAWINGS

FIGS. 1 to 5 show constructional views of optical apparatus for augmented reality according to an embodiment of the present invention.

FIG. 6 shows a view illustrating a method of manufacturing an optical apparatus for augmented reality according to an embodiment of the present invention.

FIG. 7 is a diagram showing the effect of an optical apparatus for augmented reality according to an embodiment of the present invention.

FIGS. 8 and 9 show schematic diagrams of an optical apparatus for augmented reality applied to glasses according to an embodiment of the present invention.

### DETAILED DESCRIPTION OF THE EMBODIMENTS

Hereinafter, Hereinafter, the embodiments disclosed in this specification will be described in detail with reference to the attached drawings. However, regardless of the reference numerals, identical or similar components will be given the same reference numbers and duplicate descriptions thereof will be omitted. The suffixes “module” and “part” for the components used in the following description are given or used interchangeably only for the ease of preparing the specification, and do not have distinct meanings or roles in themselves.

Additionally, in describing the embodiments disclosed in this specification, if it is determined that detailed descriptions of related known technologies may obscure the gist of the embodiments disclosed in this specification, the detailed descriptions will be omitted. In addition, the attached drawings are only for easy understanding of the embodiments disclosed in the present specification, and the technical idea disclosed in the present specification is not limited by the attached drawings, and all changes included in the spirit and technical scope of the present invention are not limited, should be understood to include equivalents or substitutes.

When it is mentioned that component is “connected” or “connected” to another component, it may be directly connected or connected to the other component, but it should be understood that other components may exist in the middle. On the other hand, when it is mentioned that a component is “directly connected” to another component, it should be understood that there are no other components in between.

Singular expressions include plural expressions unless the context clearly indicates otherwise.

In this specification, it should be understood that terms such as “include” or “have” are used in the specification are intended to designate the presence of a listed feature, number, step, operation, component, part, or combination thereof, and the terms do not exclude the possibility of the presence or absence of one or more other features, numbers, steps, operations, components, parts, or combinations thereof.

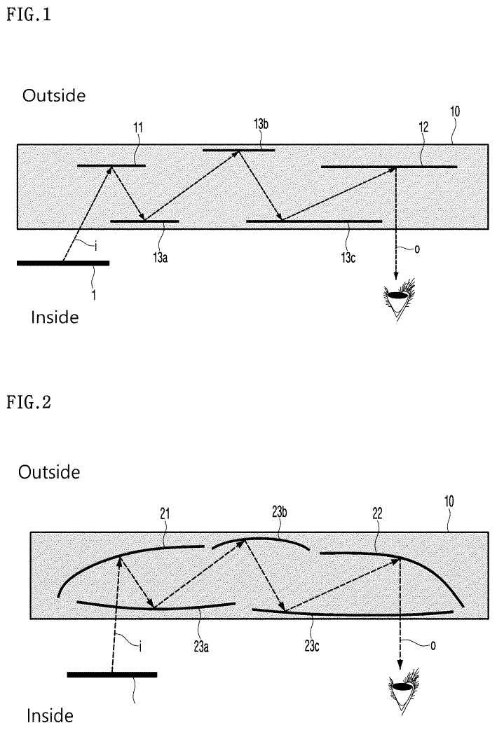

FIGS. 1 to 5 show constructional views of optical apparatus for augmented reality according to an embodiment of the present invention.

As shown in FIGS. 1 to 5, an optical apparatus for augmented reality according to an embodiment of the present invention includes an optical plate 10 to which light emitted from the display 1 is incident, and two or more reflective surfaces 11 to 63c included in the optical plate 10 and having geometric surfaces. At this time, the light emitted from the display 1 forms a predetermined optical path by the reflecting surfaces 11 to 63c and is guided into the user's view, thereby visually providing a virtual image or image to the user. At the same time, subjects such as objects or environments in the real world pass through the optical plate 10 and are visually provided to the user, so that the virtual image or image is superimposed on the subject in the real world, allowing the user to view the virtual image or image as if as if the image actually exists in the real world.

The optical plate 10 is a plate shape with light transparency and has two or more reflective surfaces 11 to 63c. Accordingly, when emitted light from the display 1 is incident on one side, the emitted light may be reflected by the reflective surfaces 11 to 63c and guided into the user's view.

At this time, based on the optical plate 10 having a predetermined thickness and width, the direction (i) in which the light emitted from the display 1 is incident on the optical plate 10 and the direction (o) in which the light is emitted from the optical plate 10 into the user's view may be the same inwardly.

In this specification, for easy explanation of the present invention, with respect to the optical plate 10, the inside of the optical plate 10 is shown in the direction i in which the light emitted from the display 1 is incident based on the optical plate 10 and/or may indicate the direction o in which light is emitted to the user's view, and the outside of the optical plate 10 may indicate the direction in which a subject in the real world is incident, but It is not limited that the scope of the present invention is defined in the corresponding term.

At this time, based on the optical plate 10, it is preferable that the direction i in which light emitted from the display 1 is incident and/or the direction o in which light is emitted to the user's view corresponds to the thickness direction of the optical plate 10, but does not correspond to the width direction perpendicular to the thickness direction.

As described above, the emitted light of the display 1 that is incident inside the optical plate 10 is reflected by a plurality of reflective surfaces 11 to 63c, and may form a predetermined optical path within the optical plate 10. At this time, the optical path according to an embodiment of the present invention may not include a path reflected from the surface of the optical plate 10.

That is, the plurality of reflective surfaces 11 to 63c according to an embodiment of the present invention are provided within the optical plate 10, and light is incident and reflected based on the reflective surfaces 11 to 63c to form the optical path, but reflection may not occur on the externally exposed surface of the optical plate 10.

In addition, on the outer surface of the optical plate 10, there may be provided lens for collecting or dispersing light, but a light reflection element such as a mirror whose optical path may be converted, a light decomposition element such as a prism, or a light refraction element may not be provided.

However, in the optical plate 10 according to an embodiment of the present invention, it is preferable to apply a high refractive index material to the optical plate 10 so that the thickness of the optical plate becomes thinner by lowering the critical angle at which total internal reflection occurs inside the optical plate, and then increasing the allowable internal reflection angle of internal light.

In the present invention, the material of the optical plate is preferably made of a high refractive index material of 1.6 or more, and accordingly, the thickness of the optical plate 10, which forms the optical path described later, may be 5 mm to 12 mm.

Meanwhile, as described above, the reflective surfaces 11˜63c according to an embodiment of the present invention may be included in the optical plate 10.

Reflective surfaces 11˜63c may reflect light entered at a predetermined incidence angle based on the normal line of the reflecting surface at the same reflection angle. The present invention does not specifically limit the type of the geometric surface of the reflective surfaces 11 to 63c, but the type may be a planar surface, a spherical surface, an aspherical surface, a parabolic surface, a freeform surface, or a combination thereof.

Specifically, as shown in FIGS. 1 to 5, the reflective surfaces 11 to 63c included in the optical plate 10 may include a first reflective surface that first reflects light which is emitted from the display 1 and enters inside through the inner surface of the optical plate 10, a second reflective surface that last reflects light to be emitted toward the user's view outside through the inner side of the optical plate 10, and third reflective surface that is arranged to reflect the light reflected at the first reflective surface to the second reflective surface along a predetermined optical path between the first and second reflective surfaces.

Reference numerals 11, 21, 31, 41, 51, and 61 may indicate the first reflective surface, reference numerals 12, 22, 32, 42, 52, and 62 may refer to the second reflecting surface, and reference numerals a pair of 13a to 13c, a pair of 23a to 23c, a pair of 33a to 33c, a pair of 43a to 43c, a pair of 53a to 53c and a pair of 63a to 63c may refer to the third reflective surface.

The present invention does not particularly limit the number of the third reflective surfaces provided in the optical plate 10. The number may be at least one but the third reflective surfaces according to a specific embodiment may be three for easy description of the present invention. That is, the third reflective surface may include 3a reflective surface that uses the reflected light of the first reflective surface as incident light, 3c reflective surface that uses the incident light of the second reflective surface as reflected light, 3b reflective surface that uses incident light of the 3c reflective surface as reflected light.

Reference numerals 13a, 23a, 33a, 43a, 53a, and 63a may refer to the 3a reflective surface, reference numerals 13b, 23b, 33b, 43b, 53b, and 63b may refer to the 3b reflective surface, and reference numerals 13c, 23c, 33c, 43c, 53c, and 63c may refer to the 3c reflective surface.

The reflective surfaces (11 to 63c) according to an embodiment of the present invention may be placed irregularly within the optical plate (10). According to a specific embodiment, the first reflective surface, the second reflective surface and the 3b reflective surface within the optical plate 10 may be located deviated toward the outside of the optical plate 10, and 3a reflective surface and 3c reflective surface within the optical plate 10 may be located deviated toward the inside of the optical plate 10. At this time, the first reflective surface, the 3a reflective surface, the 3b reflective surface, the 3c reflective surface, and the second reflective surface are arranged in order along one width direction of the optical plate 10, so that the first reflective surface reflects the incident light emitted from the display 1 and incident on the optical plate 10, the 3a reflective surface reflects the reflected light of the first reflective surface as incident light, and the 3b reflective surface reflects the reflected light of the 3a reflective surface as incident light, the second reflective surface uses the reflected light from the 3c reflective surface as incident light to reflect it to the user's view, thereby providing virtual pictures or images output from the display 1.

At this time, the reflecting surfaces 11 to 63c provided in the optical plate 10 may reflect light incident on one side, and according to a preferred embodiment, the reflective surfaces 11 to 63c preferably have a high reflectivity so as to completely reflect the incident light.

Especially, according to an embodiment of the present invention, the first reflective surface that first reflects the emitted light of the display 1 has a relatively higher reflectivity than other second and/or third reflective surfaces, whereby it is desirable to increase the efficiency of the light of the entire optical system reflected along a predetermined optical path in the optical plate 10.

As a specific embodiment, it is desirable that at least a portion of the first reflective surface has reflectivity of 30% to 100%.

Further, according to one embodiment of the present invention, at least a portion of the second reflective surface, which finally reflects the emitted light of the display 1, as a specific embodiment, may have a reflectivity of 3% to 100%, preferably 30% to 100% or 50% to 90%.

The second reflective surface at the end of the light path provides virtual images or pictures to the user's view finally so that in order to provide the real-world objects to the user's view, the second reflective surface may have a maximum reflectivity of less than 100%. However, it may have a reflectivity of 100% when providing virtual images or pictures only as needed.

Furthermore, among the plurality of reflective surfaces 11-63c provided in the optical plate 10, portions of at least one pair adjacent to each other may be arranged so as to partially overlap in the thickness direction. Thereby, a predetermined optical path may be formed. Here, the present invention is not particularly limited as to the location or area of the overlapping area.

For example, a pair of a first reflective surface and a 3a reflective surface, a pair of 3a reflective surface and 3b reflective surface, a pair of 3b reflective surface and 3c reflective surface, and a pair of 3c reflective surface and second reflective surface may each partially overlap a predetermined area in the thickness direction to form a predetermined optical path.

Without limitation, according to one embodiment of the present invention, the first reflective surface and the display 1 are also arranged so that they partially overlap in the thickness direction. In particular, by arranging the overlap region between the first reflective surface and the display 1 to be relatively wider than the overlap region of the other reflective surface, the entire optical system can be made to have a high light reflectivity accordingly.

Meanwhile, an optical system according to a specific embodiment of the present invention will be described below. optical system according to a specific embodiment of the present invention.

### First Embodiment

As shown in FIG. 1, first to third reflective surfaces 11-13c are provided within the optical plate 10, wherein the first to third reflective surfaces 11-13c may be planar. That is, one side of the first to third reflective surfaces 11-13c on which reflection occurs may be a plane.

At this time, the optical plate 10 may receive light emitted from the display 1 spaced apart in the inward direction. The first reflective surface 11 of the plane may be located outwardly biased within the optical plate 10 to reflect the emitted light of the display 1 toward the reflective surface 13a as incident light. A reflective surface 13a of the plane may be located inwardly biased within the optical plate 10 to reflect reflected light from the first reflective surface 11 as incident light toward the reflective surface 13b. The reflective surface 13b of the plane is located outwardly biased within the optical plate 10 to reflect reflected light from the third reflective surface 13a as incident light toward the reflective surface 13c. The reflective surface 13c of the plane is located inwardly biased within the optical plate 10 to reflect reflected light from the reflective surface 13b as incident light toward the second reflective surface 12. The second reflective surface 12 of the plane may be outwardly biased within the optical plate 10 to reflect reflected light from the reflective surface 13c as incident light toward the user's view.

The first to 3c reflective surfaces 11 to 13c in the optical plate 10 are arranged atypically. However, the first reflective surface 11, the reflective surface 13b, and the second reflective surface 12 may face each other with the reflective surface 13a and the reflective surface 13c. At this time, the first reflective surface 11 and the display 1 may be arranged so that portions of them overlap in the thickness direction of the optical plate 10.

Furthermore, as shown in FIG. 1, between the first reflective surface 11 and the reflective surface 13b, between the reflective surface 13c and the reflective surface 3b, and 12, and between the reflective surface 13c and the second reflective surface 12, some of the facing portions may be arranged to overlap in the thickness direction of the optical plate 10.

Here, the first reflective surface 11, the reflective surface 13a, the reflective surface 13b, the reflective surface 13c, and the second reflective surface 12 may be arranged in order along one of the width directions of the optical plate 10.

In this case, one side of the first reflective surface 11 may have a reflectivity of at least 80%, preferably 100%.

### Second Embodiment

As shown in FIG. 2, the optical plate 10 is provided with first to third reflective surfaces 21-23c, wherein the first to third reflective surfaces 21-23c may be freeform surfaces. In other words, one side of the first to third reflective surfaces 21-23c on which reflection occurs may be a free from surface.

At this time, the optical plate 10 may receive the light i emitted from the display 1 spaced apart in the inward direction. The first reflective surface 21 of the freeform surface may be located outwardly biased within the optical plate 10 to reflect the emitted light of the display 1 toward the reflective surface 23a as incident light. A reflective surface 23a of the freeform surface may be located inwardly biased within the optical plate 10 to reflect reflected light from the first reflective surface 21 as incident light toward the reflective surface 23b. The reflective surface 23b of the freeform surface may be located outwardly biased within the optical plate 10 to reflect reflected light from the reflective surface 23a as incident light toward the reflective surface 23c. The reflective surface 23c of the freeform surface may be located inwardly biased within the optical plate 10 to reflect reflected light from the reflective surface 23b as incident light toward the second reflective surface 22.

The second reflective surface 12 of the freeform surface may be outwardly biased within the optical plate 10 to reflect reflected light from the reflective surface 23c as incident light toward the user's view.

The first to 3c reflective surfaces 21 to 23c in the optical plate 10 are arranged atypically. However, the first reflective surface 21, the reflective surface 23b, and the second reflective surface 22 may face each other with the reflective surface 23a and the reflective surface 23c. The faced portion of each reflective surface may be concave. At this time, the first reflective surface 21 and the display 1 may be arranged so that portions of them overlap in the thickness direction of the optical plate 10.

Furthermore, as shown in FIG. 2, between the first reflective surface 21 and the reflective surface 23a, between the reflective surface 23a and the reflective surface 23b, between the reflective surface 23b and the reflective surface 23c, and the reflective surface 23c and the second reflective surface 22, some of the facing portions may be arranged to overlap in the thickness direction of the optical plate 10. Here, along any one width direction of the optical plate 10, the first reflective surface 21, the reflective surface 23a, the reflective surface 23b, the reflective surface 23c, and second reflective surface 22 may be arranged in any order.

Accordingly, incident light from the display 1 to the optical plate 10 may penetrate through the reflective surface 23a.

In this case, one side of the first reflective surface 21 may have a reflectivity of at least 80%, preferably 100%.

Furthermore, the reflected light O of the second reflective surface 22 may transmit the reflective surface 23c. To this end, a portion of the reflective surface 23c through which the reflected light O of the second reflective surface 22 is transmitted is not provided with a reflective coating film or the like, so that it may be light transmissive.

On the other hand, when the reflective surfaces 11-63c according to one embodiment of the present invention are freeform surfaces, the freeform surface may be described by a polynomial consisting of the following equation 1.

$$z = \frac{( {cr}^{2} )}{1 + \sqrt{1 - ( 1 + k ) {c}^{2} {r}^{2}}} + {\sum }_{j = 2}^{66} {c}_{j} {x}^{m} {y}^{n} \qquad [ Equation 1 ]$$

wherein, the z is the distance (sag) from the z-axis of a certain point on the surface in the direction of the thickness of the optical plate 10, the c is the vertex curvature of the curved surface, the k is the Conic constant, the cⱼ is the coefficient of the monomial x^{m}yⁿ, and the j is as shown in Equation 2 below.

$$j = \frac{{( m + n )}^{2} + m + 3 n}{2} + 1 \qquad [ Equation 2 ]$$

wherein the m and n are positive integers whose sum is 10 or less, and both m and n may not be zero.

### Third Embodiment

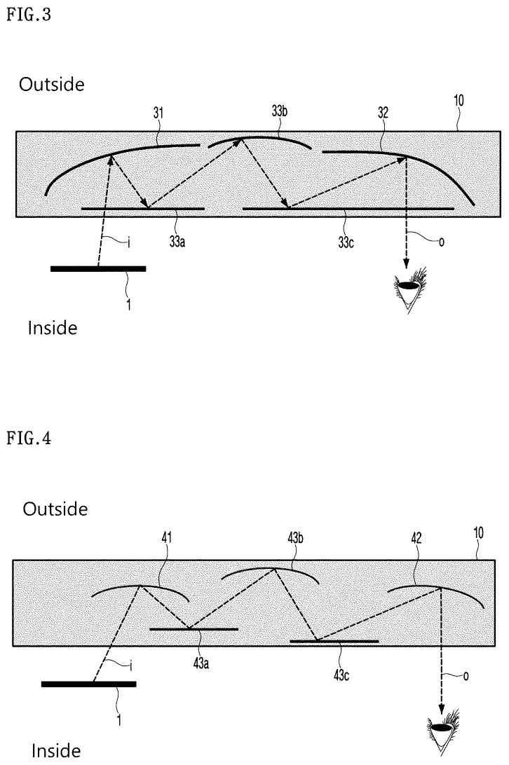

As shown in FIG. 3, a first to a third reflective surfaces 31-33c are provided within the optical plate 10. Here, the first reflective surface 31, the reflective surface 33b and the second reflective surface 32 disposed opposite the display 1 or the user's view may be a freeform surface, and the reflective surface 33a and the reflective surface 33c arranged opposite the first reflective surface 31, the reflective surface 33b, and the second reflective surface 32 may be a plane.

That is, one side of the first reflective surface 31, the reflective surface 33b and the second reflective surface 32 may be a freeform surface. And, one side of the reflective surface 33a and the reflective surface 33c may be a plane.

At this time, the optical plate 10 may receive the light i emitted from the display 1 spaced apart in the inward direction. The first reflective surface 31 of the freeform surface may be located outwardly biased within the optical plate 10 to reflect the emitted light of the display 1 toward the reflective surface 33a as incident light. A reflective surface 33a of the planar surface may be located inwardly biased within the optical plate 10 to reflect reflected light from the first reflective surface 31 as incident light toward the reflective surface 33b. The reflective surface 33b of the freeform surface may be located outwardly biased within the optical plate 10 to reflect reflected light from the reflective surface 33a as incident light toward the reflective surface 13c. The reflective surface 33c of the planar surface may be located inwardly biased within the optical plate 10 to reflect reflected light from the reflective surface 33b as incident light toward the second reflective surface 32. The second reflective surface 32 of the freeform surface may be outwardly biased within the optical plate 10 to reflect reflected light from the reflective surface 33c as incident light toward the user's view.

The first to 3c reflective surfaces 31 to 33c in the optical plate 10 are arranged atypically. However, the first reflective surface 31, the reflective surface 33b, and the second reflective surface 32 may face each other with the reflective surface 33a and the reflective surface 33c. The freeform surface of the first reflective surface 31, reflective surface 33b and the second reflective surface 32 may be concave. At this time, the first reflective surface 41 and the display 1 may be arranged so that portions of them overlap in the thickness direction of the optical plate 10.

Furthermore, as shown in FIG. 3, between the first reflective surface 31 and the reflective surface 33a, between the reflective surface 33a and the reflective surface 33b, between the reflective surface 33b and the reflective surface 33c, and the reflective surface 33c and the second reflective surface 32, some of the facing portions may be arranged to overlap in the thickness direction of the optical plate 10. Here, along any one width direction of the optical plate 10, the first reflective surface the reflective surface 33a, the reflective surface 33b, the reflective surface 33c, and second reflective surface 32 may be arranged in any order.

Accordingly, incident light from the display 1 to the optical plate 10 may penetrate through the reflective surface 33a.

In this case, one side of the first reflective surface 31 may have a reflectivity of at least 80%, preferably 100%.

Furthermore, the reflected light O of the second reflective surface 32 may transmit the reflective surface 33c. To this end, a portion of the reflective surface 33c through which the reflected light O of the second reflective surface 32 is transmitted is not provided with a reflective coating film or the like, so that it may be light transmissive.

Likewise, According to one embodiment of the present invention, the freeform surface of the first reflective surface 31, the reflective surface 33c and the second reflective surface 32 can be described by a polynomial consisting of equation 1.

### Fourth Embodiment

As shown in FIG. 4, a first to a third reflective surfaces 41-43c are provided within the optical plate 10. Here, the first reflective surface 41, the reflective surface 43b and the second reflective surface 42 arranged opposite the display 1 or the user's view may be a spheric surface, and the reflective surface 43a and the reflective surface 43c arranged opposite the first reflective surface 41, the reflective surface 43b, and the second reflective surface 42 may be a plane.

That is, one side of the first reflective surface 41, the reflective surface 43b and the second reflective surface 42 may be a planar surface. And, one side of the reflective surface 43a and the reflective surface 43c may be a plane.

At this time, the optical plate 10 may receive the light i emitted from the display 1 spaced apart in the inward direction. The first reflective surface 41 of the spheric surface may be located outwardly biased within the optical plate 10 to reflect the emitted light of the display 1 toward the reflective surface 43a as incident light. A reflective surface 43a of the planar surface may be located inwardly biased within the optical plate 10 to reflect reflected light from the first reflective surface 41 as incident light toward the reflective surface 43b. The reflective surface 43b of the spheric surface may be located outwardly biased within the optical plate 10 to reflect reflected light from the reflective surface 43a as incident light toward the reflective surface 43c. The reflective surface 43c of the planar surface may be located inwardly biased within the optical plate 10 to reflect reflected light from the reflective surface 43b as incident light toward the second reflective surface 42. The second reflective surface 42 of the spheric surface may be outwardly biased within the optical plate 10 to reflect reflected light from the reflective surface 43c as incident light toward the user's view.

The first to 3c reflective surfaces 41 to 43c in the optical plate 10 are arranged atypically. However, the first reflective surface 41, the reflective surface 43b, and the second reflective surface 42 may face each other with the reflective surface 43a and the reflective surface 43c. The spheric surface of the first reflective surface 41, reflective surface 43b and the second reflective surface 42 may be concave. At this time, the first reflective surface 41 and the display 1 may be arranged so that portions of them overlap in the thickness direction of the optical plate 10.

Furthermore, as shown in FIG. 4, between the first reflective surface 41 and the reflective surface 43a, between the reflective surface 43a and the reflective surface 43b, between the reflective surface 43b and the reflective surface 43c, and the reflective surface 43c and the second reflective surface 32, some of the facing portions may be arranged to overlap in the thickness direction of the optical plate 10. Here, along any one width direction of the optical plate 10, the first reflective surface 41, the reflective surface 43a, the reflective surface 43b, the reflective surface 43c, and second reflective surface 42 may be arranged in any order.

At this time, one side of the first reflective surface 41 may have a reflectivity of at least 80%, preferably 100%.

### Fifth Embodiment

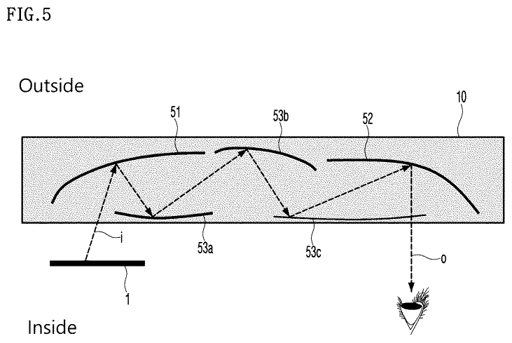

As shown in FIG. 5, a first to a third reflective surfaces 51-53c are provided within the optical plate 10. Here, the first reflective surface 51, the reflective surface 53b and the second reflective surface 52 arranged opposite the display 1 or the user's view may be a freeform surface, and the reflective surface 53a of the reflective surfaces 53a and 53c that are arranged opposite the first reflective surface 51, the reflective surface 53b and the second reflective surface 52 may be a freeform surface and he reflective surface 3c may be a spheric surface.

That is, one side of the first reflective surface 51, the reflective surface 53b and the second reflective surface 52 may be a freeform surface. And, one side of the reflective surface 53a may be a freeform surface, and one side of the reflective surface 53c may be a spheric surface.

At this time, the optical plate 10 may receive the light i emitted from the display 1 spaced apart in the inward direction. The first reflective surface 51 of the freeform surface may be located outwardly biased within the optical plate 10 to reflect the emitted light of the display 1 toward the reflective surface 53a as incident light. A reflective surface 53a of the freeform surface may be located inwardly biased within the optical plate 10 to reflect reflected light from the first reflective surface 51 as incident light toward the reflective surface 53b. The reflective surface 53b of the freeform surface may be located outwardly biased within the optical plate 10 to reflect reflected light from the reflective surface 53a as incident light toward the reflective surface 53c. The reflective surface 53c of the spheric surface may be located inwardly biased within the optical plate 10 to reflect reflected light from the reflective surface 53b as incident light toward the second reflective surface 52. The second reflective surface 52 of the freeform surface may be outwardly biased within the optical plate 10 to reflect reflected light from the reflective surface 53c as incident light toward the user's view.

The first to 3c reflective surfaces 51 to 53c in the optical plate 10 are arranged atypically. However, the first reflective surface 51, the reflective surface 53b, and the second reflective surface 52 may face each other with the reflective surface 53a and the reflective surface 53c. The spheric surface of the first reflective surface 51, reflective surface 53b and the second reflective surface 52 may be concave. And, the freeform of the reflective surface 53a and the curved surface of the reflective surface 53c may also be concave.

Furthermore, as shown in FIG. 5, between the first reflective surface 51 and the reflective surface 53a, between the reflective surface 53a and the reflective surface 53b, between the reflective surface 53b and the reflective surface 53c, and the reflective surface 53c and the second reflective surface 52, some of the facing portions may be arranged to overlap in the thickness direction of the optical plate 10. Here, along any one width direction of the optical plate 10, the first reflective surface 51, the reflective surface 53a, the reflective surface 53b, the reflective surface 53c, and second reflective surface 52 may be arranged in any order.

At this time, one side of the first reflective surface 51 may have a reflectivity of at least 80%, preferably 100%.

Furthermore, the reflected light O of the second reflective surface 52 may transmit the reflective surface 53c. To this end, a portion of the reflective surface 53c through which the reflected light O of the second reflective surface 52 is transmitted is not provided with a reflective coating film or the like, so that it may be light transmissive.

Likewise, According to one embodiment of the present invention, the freeform surface of the first reflective surface 51, the reflective surface 53c and the second reflective surface 52 can be described by a polynomial consisting of equation 1.

### Sixth Embodiment

All or a portion of the reflective surfaces 11-63c according to any of the preceding first to fifth embodiments may be a symmetrical or asymmetrical freeform surface according to any of the following equations 3 to 5.

$${T}_{n} ( x ) = cos ( n {cos}^{- 1} ( x ) ) , n = 0 … ∞ , x ∈ [ - 1 , 1 ] \qquad [ Equation 3 ]$$

$$z = \frac{c ( {x}^{2} + {y}^{2} )}{1 + \sqrt{1 - {c}^{2} ( {x}^{2} + {y}^{2} )}} + {\sum }_{i = 0}^{N} {\sum }_{j = 0}^{M} {a}_{ij} \cdot {T}_{i} ( \overline{x} ) \cdot {T}_{j} ( \overline{y} ) \qquad [ Equation 4 ]$$

$${t}_{ij} ( x , y ) = {T}_{i} ( x ) \cdot {T}_{j} ( y ) , i , j = 0 … ∞ , x ∈ [ - 1 , 1 ] , y ∈ [ - 1 , 1 ] \qquad [ Equation 5 ]$$

here, z is the distance (sag) from the z axis of a specific point on the surface, aᵢⱼ is the coefficient of a Chebyshev Polynomial term, x and y are normalized surface coordinates, and n and m are the maximum polynomial degree in the x and y dimensions, and c is the curvature of the basic sphere to which the polynomial is added.

### Seventh Embodiment

All or a portion of the reflective surfaces 11-63c according to any of the preceding first to fifth embodiments may be a geometric surface in the form of a sphere, asphere, ellipse, parabola, or hyperbola that is in accordance with the equation 6 below.

$$z ( h ) = \frac{{h}^{2}}{{R}_{s} [ 1 + \sqrt{1 - ( 1 + k ) {( \frac{h}{{R}_{s}} )}^{2}} ]} + {\sum }_{n = 2}^{m} {A}_{2 n} {h}^{2 n} \qquad Equation 6$$

Here, h is a radial coordinate, Rₛ is a constant vertex radius, k is a Conic constant, and A₂ₙ is a coefficient of a polynomial. k>0 when the geometric curved surface is an oblate parabola, k=0 when the geometric curved surface is a sphere, −1<k<0 when said surface is a prolate parabola, k=−1 when the surface is a parabola, or k=−1 when the surface is a hyperbola.

### How to Manufacture

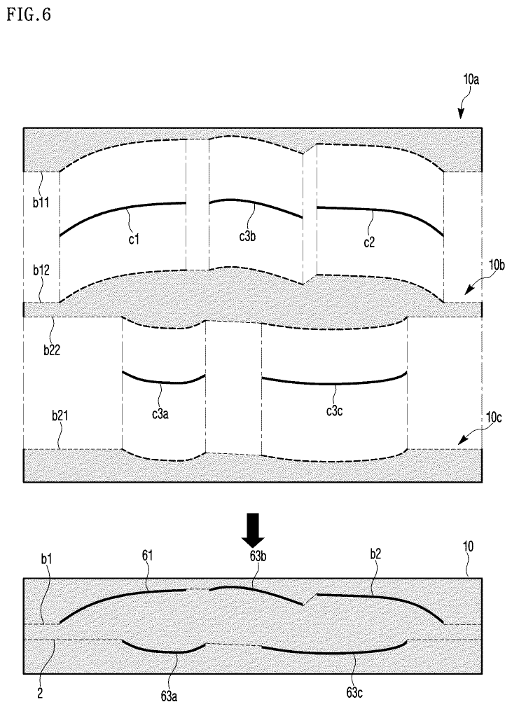

FIG. 6 shows a view illustrating a method of manufacturing an optical apparatus for augmented reality according to an embodiment of the present invention.

As shown in FIG. 6, in accordance with one embodiment of the present invention, in order to manufacture an optical plate 10 having a plurality of reflective surfaces 11-63c, a plurality of subplates 10a-10c may be stacked.

The plurality of subplates 10a-10c may be stacked in the thickness direction to create the optical plate 10. At this time, the present invention is not particularly limited as to the number of subplates 10a˜10c that are stacked to create the optical plate 10, but as a specific example, three subplates 10a˜10c may be stacked to create the optical plate 10.

Additionally, each of the subplates 10a-10c is formed to engage a side of the subplate 10a-10c that abuts another adjacent subplate 10a-10c, but the boundary between the neighboring subplates 10a˜10c is formed in the form of a reflective surface 11˜63c embedded in the optical plate 10.

The surface abutting each of the subplates 10a-10c may have a shape corresponding to the reflective surfaces 11-63c embedded in the optical plate 10. In this case, at least one coating film C1˜C3 may be interposed between the subplates 10A˜10C facing each other on the basis of the machined surface, at a position corresponding to said reflective surfaces 11˜63C. Here, the coating films C1˜C3 interposed at positions corresponding to the reflective surfaces 11˜63C may be arranged to cover at least a portion of said reflective surfaces 11˜63C. In one specific example, a first subplate 10a on the top, a third subplate 10c on the bottom, and a second subplate 10b interposed between the first and third subplates 10a, 10c are laminated in the thickness direction. Thus, an optical plate 10 may be generated, in which a first coating film C1, a second coating film C2, and a third coating film 33b may be interposed between the first subplate 10a and the second subplate 10b.

In this case, as shown in FIGS. 1 to 5, the first subplate 10a may have an interface surface b1 based on shapes of a first reflective surface, a reflective surface 3b and a second reflective surface. The second subplate 10b may have one second interfacial surface B2 based on a third reflective surface and a third reflective surface on one side.

A third subplate 10c interposed between the first and second subplates 10a and 10b may be formed to engage the first and second interfaces b1 and b2 on both sides, and the optical plate 10 may be formed by laminating and coupling the first to third subplates 10a to 10c that are divided.

### Experiment

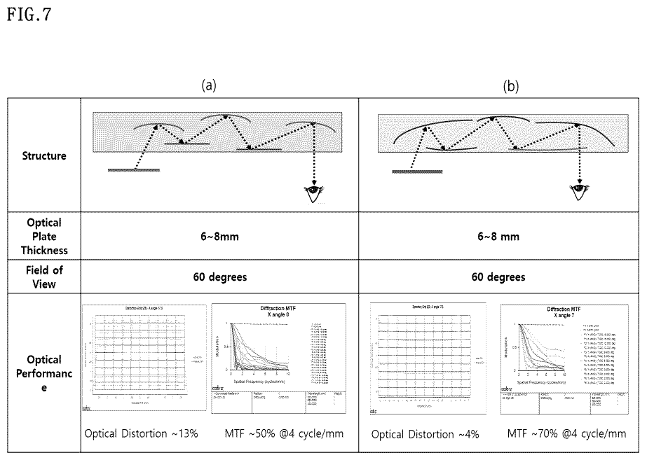

FIG. 7 is a diagram showing the effect of an optical apparatus for augmented reality according to an embodiment of the present invention.

FIGS. 7(a) and (b), respectively, relate to optical plates 10 manufactured according to the embodiments 4 and 5 above, and each of the optical plates 10 may have a predetermined thickness, field of view, and optical performance.

In other words, the optical plate 10 according to one embodiment of the present invention may have a thickness of 6 mm to 8 mm, and the user can obtain a field of view, 60° by a predetermined light path formed by the first to third reflective surfaces 11-63c.

Nevertheless, the optical plate 10 according to one embodiment of the present invention has low distortion, within 13% or 4%, and MTF (Modulation Transfer Function) is within 50% or 70%, indicating that the reproduction performance of the virtual reality image or picture is high.

### Application

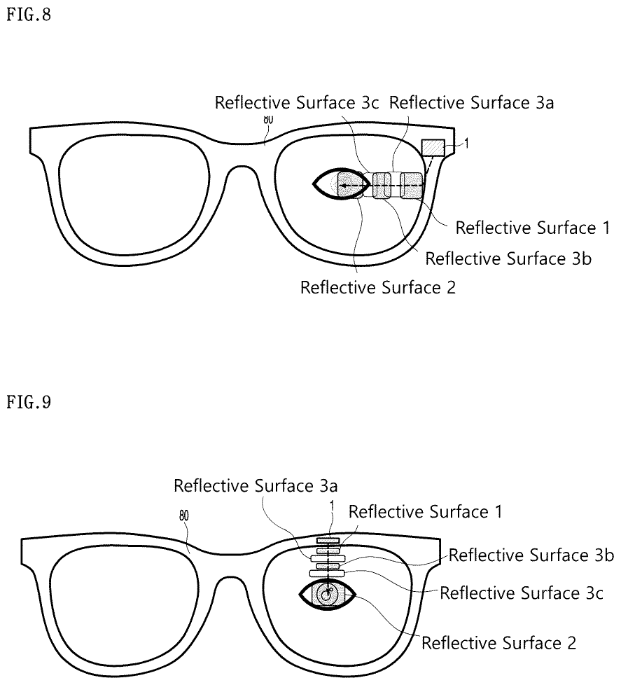

FIGS. 8 and 9 show schematic diagrams of an optical apparatus for augmented reality applied to glasses according to an embodiment of the present invention.

As shown in FIGS. 8 and 9, an optical apparatus for augmented reality according to one embodiment of the present invention may be applied to eye glasses.

In this case, the display (1) of the optical apparatus for augmented reality may be located on one side of the glasses or the frame of the glasses, and the optical path of the optical apparatus for augmented reality may be implemented to be horizontal, vertical, diagonal, or a combination thereof.

In one specific example, the optical path is arranged approximately along the transverse direction of the glasses, as shown in FIG. 8, or approximately along the longitudinal direction of the glasses, but the invention is not specifically limited thereto.

Meanwhile, in the context of the present invention, reflective surfaces conforming to mathematical expressions means that the SAG (position coordinate) values for the areas where the light rays are actually incident on and reflected from the processed surfaces agree within a reasonable range of approximation with the SAG (position coordinates) calculated by the equations described herein. The range of such approximation may vary depending on the processing technology, for example, the approximation between the equations and the reflective surface may be at least 50%, and may be as high as 100%. The scope of the invention covers all cases where such an approximation between the equation and the actual reflective surface occurs.

Preferred embodiments of the present invention have now been described in detail with reference to the drawings.

The description of the invention is for illustrative purposes only, and one having ordinary knowledge in the technical field to which the invention belongs will understand that it can be easily adapted to other specific forms without changing the technical idea or essential features of the invention.

Accordingly, the scope of the invention is indicated by the following claims, rather than by the detailed description above, and scope, meaning, scope, and all modifications or variations derived from the equivalents of the patent claims shall be construed to include the scope of the invention.

What is claimed is:

1. An optical device for augmented reality, comprising:
an optical plate onto which light emitted from a display is incident; and
a reflective surface having a shape of one or more free-form surfaces, one or more aspherical surfaces, one or more parabolic surfaces, or one or more conical surfaces, the reflective surface being contained in the optical plate, or a reflective surface having a shape of one or more free-form surfaces, one or more aspherical surfaces, one or more parabolic surfaces, or one or more conical surfaces, the reflective surface being contained in the optical plate and having a shape of one or more planar surfaces or one or more spherical surfaces;
wherein the emitted light forms a predetermined optical path by the reflective surface and is guided into the user's view, and the optical path does not include a path reflected from the surface of the optical plate.

2. The optical apparatus according to claim 1, wherein the optical plate is made up of a plurality of subplates stacked in the thickness direction, and the subplates are formed by processing reflective surfaces with inverse shapes on surfaces facing other subplates, and then applying a reflective coating film to the reflective surfaces, to join the subplates so that the opposing reflective surfaces are in contact with each other.

3. The optical apparatus according to claim 1, wherein the reflective surface is arranged to form the optical path within the optical plate with a thickness of 5 mm to 12 mm.

4. The optical apparatus according to claim 1, wherein among the two or more reflective surfaces, a first reflective surface that first reflects the emitted light has a higher reflectivity than other reflective surfaces other than the first reflective surface.

5. The optical apparatus according to claim 4, wherein
the first reflective surface that first reflects the emitted light has at least some a reflectivity of 30% or more.

6. The optical apparatus according to claim 1, wherein
among the two or more reflective surfaces, at least a portion of a second reflective surface that last reflects into the user's view along the optical path has a reflectivity of 3% or more.

7. The optical apparatus according to claim 1, wherein
the optical plate is made of a high refractive material with a refractive index of 1.6 or more.

8. The optical apparatus according to claim 1, wherein
the reflective surfaces inside the optical plate include one or more free-form surfaces, one or more aspherical surfaces, and one or more spherical or planar reflective surfaces.

9. The optical apparatus according to claim 1, wherein
all or part of the one or more reflective surfaces are symmetrical or asymmetrical free-form surfaces that comply with Equation 1, Equation 2, and Equation 3 below,
$${T}_{n} ( x ) = cos ( n {cos}^{- 1} ( x ) ) , n = 0 … ∞ , x ∈ [ - 1 , 1 ] \qquad [ Equation 1 ]$$
$$z = \frac{c ( {x}^{2} + {y}^{2} )}{1 + \sqrt{1 - {c}^{2} ( {x}^{2} + {y}^{2} )}} + {\sum }_{i = 0}^{N} {\sum }_{j = 0}^{M} {a}_{ij} \cdot {T}_{i} ( \overline{x} ) \cdot {T}_{j} ( \overline{y} ) \qquad [ Equation 2 ]$$
$${t}_{ij} ( x , y ) = {T}_{i} ( x ) \cdot {T}_{j} ( y ) , i , j = 0 … ∞ , x ∈ [ - 1 , 1 ] , y ∈ [ - 1 , 1 ] \qquad [ Equation 3 ]$$
here, z is the distance (sag) from the z axis of a specific point on the surface, aᵢⱼ is the coefficient of a Chebyshev Polynomial term, x and y are normalized surface coordinates, and n and m are the maximum polynomial degree in the x and y dimensions, and c is the curvature of the basic sphere to which the polynomial is added.

10. The optical apparatus according to claim 1, wherein
all or part of the one or more reflective surfaces are symmetrical or asymmetrical freeform surfaces expressed in Equation 4 below,
$$z = \frac{( {cr}^{2} )}{1 + \sqrt{1 - ( 1 + k ) {c}^{2} {r}^{2}}} + {\sum }_{j = 2}^{66} {c}_{j} {x}^{m} {y}^{n} \qquad [ Equation 4 ]$$
here, z is the distance (sag) from the z-axis of a specific point on the surface, c is the vertex curvature of the curved surface, k is the Conic constant, and cⱼ is the coefficient of the monomial x^{m}yⁿ, and j is expressed in Equation 5 below,
$$j = \frac{{( m + n )}^{2} + m + 3 n}{2} + 1 \qquad [ Equation 5 ]$$
here, m and n are positive integers whose sum is 10 or less, and both m and n are not equal to 0.

11. The optical apparatus according to claim 1, wherein
all or part of the one or more reflective surfaces are expressed in Equation 6 below, and are geometric surfaces in the form of spherical surface, aspherical surface, elliptic surface, parabolic surface, or hyperbolic surface,
$$z ( h ) = \frac{{h}^{2}}{{R}_{s} [ 1 + \sqrt{1 - ( 1 + k ) {( \frac{h}{{R}_{s}} )}^{2}} ]} + {\sum }_{n = 2}^{m} {A}_{2 n} {h}^{2 n} \qquad [ Equation 6 ]$$
Here, h is a radial coordinate, Rₛ is a vertex radius, k is a Conic constant, A₂ₙ is a coefficient of a polynomial, and when the geometric curved surface is oblate and paraboloid, k>0, when the geometric curved surface is a sphere, k=0, when the geometric curved surface is a conical paraboloid,
−1<k<0, when the geometric curved surface is a paraboloid, k=−1, or when the geometric curved surface is a hyperboloid, k<−1.

12. The optical apparatus according to claim 1, wherein
the two or more reflective surfaces include a first reflective surface that first reflects the emitted light, a second reflective surface that finally reflects light into the user's view along the optical path, and a third reflective surface that is provided on the optical path between the first and second reflective surfaces to reflect light, and the third reflective surface includes a 3a reflective surface that uses the reflected light of the first reflective surface as incident light, a 3c reflective surface that uses the incident light of the second reflective surface as reflected light, and a 3b reflective surface that uses the incident light of the 3c reflective surface as reflected light.

13. The optical apparatus according to claim 10, wherein
the first, second, and 3b reflective surfaces are free-form or aspherical surfaces, and the 3a and 3c reflective surfaces are planar or spherical surfaces.

14. The optical apparatus according to claim 10, wherein
the first, second, 3a, 3b, and 3c reflective surfaces are free-form surfaces.

15. Glasses including the optical apparatus for augmented reality according to any one of claims 1 to 14, wherein a display is located on one side of the glasses, and an optical path is formed in the horizontal or vertical direction of the glasses.
